(19) United States
(12) Patent Application Publication
(10) Pub. No.: US 2014/0340423 A1
(43) Pub. Date: Nov. 20, 2014

(54) Marker-based augmented reality (AR) display with inventory management

(71) Applicant: NEXREF Technologies, LLC, Dallas, TX (US)

(72) Inventors: David A. Taylor, Dallas, TX (US); Justin Fahey, Flower Mound, TX (US); Baylor Barbee, Dallas, TX (US); Yogendra Singh Rawat, Hyderabad (IN); Prakash Maddipatia, Dallas, TX (US); Gary C. Haymann, Dallas, TX (US); William Robert English, Plano, TX (US)

(73) Assignee: NEXREF Technologies, LLC, Dallas, TX (US)

(21) Appl. No.: 14/214,713

(22) Filed: Mar. 15, 2014

Related U.S. Application Data
(60) Provisional application No. 61/791,764, filed on Mar. 15, 2013.

(51) Int. Cl. G06T 19/00; G06T 7/00; G06K 9/62

(52) U.S. Cl. CPC G06T 19/006; G06K 9/6202; G06T 7/00; G06Q 30/0257
USPC 345/633

(57) ABSTRACT

A platform to enable configuration, administration and management of augmented reality markers adapted to be scanned by an end user mobile device to enable AR experience. The platform enables control of marker provisioning by entities who decide what content should appear in mobile applications when their AR codes are scanned by end users. The platform generates unique AR markers. A marker has a first code region, and a second code region. The code regions are adapted to be scanned, preferably sequentially, and the first code region encodes a first identifier identifying an External marker ID in a pattern matching approach, and second code region that encodes a second identifier identifying an Internal marker ID in a encoding/decoding approach. In one embodiment, the first code region is generally circular and includes a central area, and the second code region is located within the central area of the first code region.

### BACKGROUND

1. Technical Field

The subject matter herein relates generally to Augmented Reality (AR) technologies and, in particular, to managing AR codes associated with products and services.

2. Description of the Related Art

Augmented reality (AR) is a live, direct or indirect, view of a real-world environment that is digitally augmented by another device. Previously, the conjunction of advertisements with technology was limited. Users were encouraged to visit advertisers' websites or to scan a black-and-white square bar code, known as a QR code, which was tacked onto posters or other printed content; the code typically encoded a URL. Thus, when then end user scanned the code with his or her mobile device camera, a browser or other application on the device would then open to a website or page associated with the URL.

In the past, interaction with QR code-based advertisements has been limited. Once a QR code is scanned, tracking of the QR code is stopped, and there is no more interaction with the code. Recently, AR-based advertisement platforms have been developed by third parties, such as Blippar, Aurasma, Layar, Zappar, and others. Thus, for example, to use Blipper, end users hold up their phones or iPads to an advertisement. After reading the layout of the image and connecting it with the app's ad database, Blippar then takes users to a website, or overlays video or game content on top of an image. Layar focuses on extending the usability of print formats, such as magazines and postcards, with interactive digital content. Zapper bases its business on T-shirts and greeting cards, which then turn into or lead to interactive games.

Existing AR technologies, such as Qualcomm® Vuforia™ SDK, include rendering runtimes and associated software development kits. Such SDKs generally provide a platform on which a user may create a “bundle” (or “dataset”) that may contain a relatively limited number (e.g., up to 100) markers for pattern recognition-based matching; that bundle, which is a marker database, is adapted to be processed into a compatible file format (e.g., a Unity3D UnityPackageFile), compiled, and then packaged together with the AR SDK into a consumer-facing AR mobile application (an “app”). When executing in the mobile runtime environment, the AR SDK makes use of the marker database when one of the markers from that database is scanned. In this known architecture, one or a limited number of datasets can be loaded in the runtime simultaneously or one at a time, and, as noted, each contains a maximum limited number of markers. While this approach works well for its intended purpose, only a few databases may be configured into the runtime, primarily because of the limited resources and processing power available, even on high-end smart devices. This known approach also does not provide for a scalable, robust solution in which it is desired to provision a large number of markers. Moreover, because the app is made available with its marker database, it is not possible to change the database in the app without updating the app itself.

Other AR technologies, such as Vuforia Cloud Recognition, provide for an alternative approach wherein the marker databases are hosted in a remote cloud server. Such solutions provide an application programming interface (API) that allows developers to create and upload markers to the remote cloud marker database. In such case, the SDK in the client app just enables the app to communicate with a remote pattern recognition API. In particular, the app t transfers scan information to the cloud server via the API which, in turn, returns information about the detected marker strings. As compared to hosting the marker databases on the device itself, a hosted solution (for the databases) does provide the ability to host and load a large number of markers, yet the benefit (of hosting) is not necessarily extensible to multiple constituencies, such as brands, marketers and advertisers. In particular, pattern recognition always finds an approximately best match; thus, to avoid a situation in which an incorrect marker identifier is returned (upon reading a given marker), all the markers in the database have to be unique from one another, uniformly throughout the marker image. As such, solutions of this type cannot be exposed from a single platform that might be shared among such multiple constituencies.

### BRIEF SUMMARY

A single platform is adapted to be shared among multiple constituencies (e.g., brands, marketers, advertisers, and the like) to provide provisioning and management of markers for use in augmented reality (AR)-based technologies. The approach is facilitated through the use of a unique marker design (or “format”) that enables the generation of a large number of individual markers that each can still be uniquely detected by pattern recognition approaches. The marker design format enables the generation of markers that contain two detectable regions, a first one being a multiplier region and that leverages an encoding/decoding paradigm, and a second one being a code that leverages pattern recognition-based marker approaches. The regions are combined together seamlessly yet are still independent from each other in a way that can be recognized or decoded during use. In one embodiment, the pattern recognition-based region, sometimes referred to as an External ID marker, contributes to detection and tracking of the marker as a whole, and this region typically holds and tracks augmented content. The encoding/decoding based-region, sometimes referred as an Internal ID marker, facilitates scaling of the approach to include a potentially unlimited number of AR markers. In particular, and as opposed to known techniques such as described above, the Internal ID marker region is not limited by database restrictions, as it is decoded (as opposed to being pattern-recognized) and thus not required to be matched against a marker database. By repeating each unique internal ID marker for each of a relatively limited number of AR markers (as defined by the External ID), the unique hybrid marker format enables the system to generate a very large pool of augmentable content.

In particular, this disclosure relates to a network-accessible platform for marker configuration, administration and management that may be used by brands, marketers, advertisers and consumers on a large scale. Thus, for example, the platform places control of marker provisioning in the hands of advertisers and marketers so that they can decide dynamically what content should appear in end user mobile applications (mobile apps) when their marker codes are scanned by end users. As noted above, the markers themselves have a unique configuration. Preferably, a marker has a first code region (the External ID marker referenced above) that encodes an identifier associated with one of a fixed number of identifiers (e.g., up to 80) in a marker bundle. The marker bundle is adapted to be provided to the mobile application runtime environment, preferably in advance of a scanning operation. Each marker also has a second code region (the Internal ID marker referenced above), preferably located within (or adjacent) the first code region, and that encodes additional information, e.g., information identifying a product, a service, an advertiser, a marketer, a marketing campaign, or the like, or some combination thereof. The additional information is encoded within the second code region in such a manner as to enable a very large number (e.g., up to 2ⁿ, where n=30) of possible encoded values. When a marker is scanned, the first code region is scanned first; the result of the scan is compared to the marker bundle (which preferably is already present on the mobile device) to determine a first data string. Typically, this operation occurs in a first processing mode (e.g., a hybrid mode) in the runtime environment. The application then switches to a second processing mode (e.g., a native mode) in the runtime environment and the second code region is scanned. The second code region is then encoded to determine a second data string. The first data string is then concatenated with the string data string (e.g., first data string_second data string) to generate a complete marker identifier. That marker identifier is then provided (e.g., via a Web services call) to the network-accessible platform. In response, the platform returns an identifier (e.g., a URI) to a particular content object that the mobile device rendering application then accesses. The content object is then streamed or downloaded to the device runtime for rendering in response to the scan. The content object itself may be supplemented with one or more overlay controls that are accessible by an end user (viewing the content) to perform additional control actions (e.g., make a call, enter into a chat, send a text message, obtain additional information, or the like) upon viewing the content.

The management platform preferably comprises one or more network-accessible computing machines, interfaces, applications and databases, and that provides a management and provisioning interface to authorized users (e.g., marketers and advertisers). The management platform, which may be cloud-based in whole or in part, supports the provisioning and management of assets that are associated to the AR markers.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

FIG. 1 is a block diagram of a service provider infrastructure for implementing an Augmented Reality (AR) marker provisioning platform according to this disclosure;

FIG. 2 illustrates a representative landing page for a provisioning site hosted by the platform;

FIG. 3 is a representative display interface by which an administrator provisions an AR marker and associates the marker with a content object;

FIG. 4A is a representative display interface by which an administrator can access basic analytical reports on the marker campaigns run by the administrator;

FIG. 4B is a representative display interface by which an administrator can access advanced analytical reports on the marker campaigns run by the administrator;

FIG. 5 is a representative marker code in one embodiment;

FIG. 6 is a simplified block diagram of the basic components of server-side architecture for use herein;

FIG. 7 is a simplified block diagram of the basic components of client-side architecture for use herein;

FIG. 8A shows a home screen of a mobile device app that hosts the marker scan functionality of this disclosure;

FIG. 8B shows a navigation panel that enables a user to explore other screens in the app, to change app settings, and to display other information about the application;

FIG. 9A shows a scanner animation of the app in a main screen when a marker is being scanned;

FIG. 9B shows the scanner screen of the app when a marker pointing to 3D content is scanned successfully and downloads the content to the device before rendering;

FIG. 9C shows the scanner screen of the app when the 3D content is successfully augmented on the marker;

FIG. 9D shows the scanner screen of the app in the main screen when a marker pointing to remote video content is scanned;

FIG. 9E shows the scanner screen of the app when the video scanned is successfully augmented and automatically rendered in a full screen mode, together with the call-to-action buttons configured for the marker by the administrator;

FIG. 10 shows the scanner screen when a marker is scanned for video content with several call-to-action buttons and in augmented mode (as opposed to full screen mode);

FIG. 11A shows a History screen of the app by which a user can view the list of all the markers scanned;

FIG. 11B shows the display of the content of a marker item when selected from the History or Favorites List View screens; and

FIG. 11C shows a popup screen that appears when a Social Media Share button is tapped for the scanned content in the scanner screen.

### DETAILED DESCRIPTION

As will be seen, a system of this disclosure may be implemented with client-side technologies (in a mobile device), and server-side technologies (in a web-accessible infrastructure). The server-side of the system is used for on-the-fly marker generation and marker provisioning, account management, and content delivery. The client device is a mobile device (e.g., a smartphone, tablet, or the like running iOS®, Android, or the like) having an AR-based application employing a pattern recognition technology such as the Qualcomm® Vuforia™ run-time environment. In the context of this disclosure, the software executing on the mobile device receives camera data (the marker image/frames), decodes the marker for marker id, and interfaces to the back-end (the server-side).

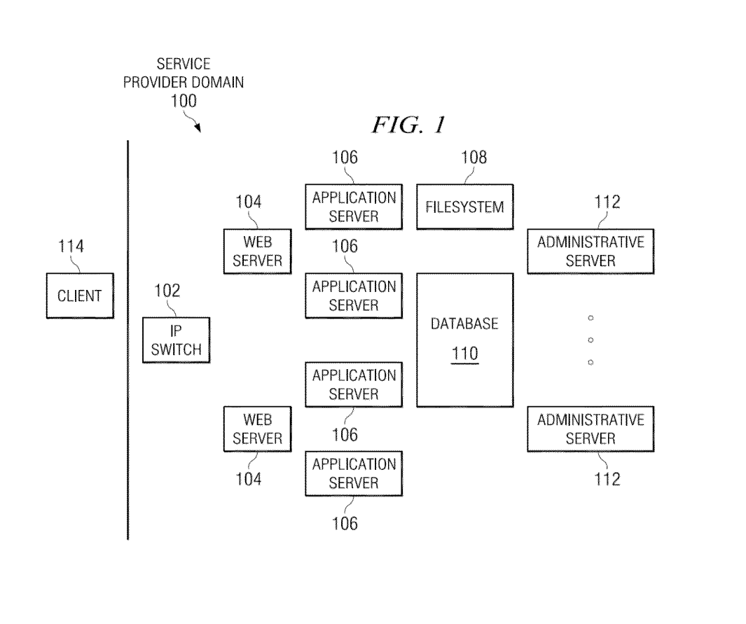

Turning first to the server-side, the configuration and provisioning techniques described below may be practiced in association with a computing infrastructure comprising one or more data processing machines. These functions (in whole or in part) may be implemented on or in association with a service provider infrastructure 100 such as seen in FIG. 1. A representative infrastructure of this type comprises an IP switch 102, a set of one or more web server machines 104, a set of one more application server machines 106, a database management system 108, and a set of one or more administration server machines 110. Without meant to be limiting, a representative technology platform that implements the service comprises machines, systems, sub-systems, applications, databases, interfaces and other computing and telecommunications resources. A representative web server machine comprises commodity hardware (e.g., Intel-based), an operating system such as Microsoft Windows Server, and a web server such as IIS (with SSL terminator) or the like. The database management system may be implemented using Microsoft SQL server, or a commercially-available (e.g., Oracle® (or equivalent)) database management package. The web-based front end implements an ASP.NET (or equivalent) web architecture, with known front-end technologies such as AJAX calls to a SOAP/REST API, jQuery UI, HTML 5 and CSS 3. In one embodiment, an IIS web server is configured to proxy requests to an ASP.NET application server. Requests are received via HTTPS. The application server technologies include, in one embodiment, ASP.NET applications, a SOAP interface, ASP-support and SQL Server database connectivity. The infrastructure also may include a name service, FTP servers, administrative servers, data collection services, management and reporting servers, other backend servers, load balancing appliances, other switches, and the like. Each machine typically comprises sufficient disk and memory, as well as input and output devices. The software environment on each machine includes a CLR. Generally, the web servers handle incoming configuration provisioning requests, and they export a management interface (typically as a set of web pages). The application servers manage the basic functions of AR marker provisioning and configuration, as will be described below.

One or more functions of such a technology platform may be implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, networking technologies, etc., that together provide the functionality of a given system or subsystem. As described, the functionality may be implemented in a standalone machine, or across a distributed set of machines.

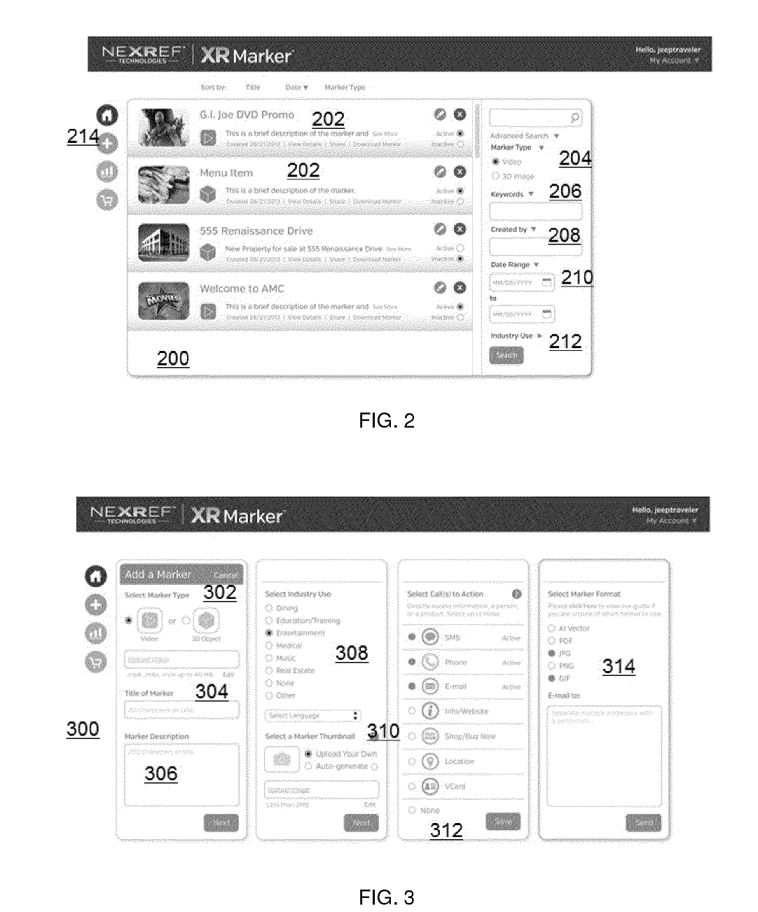

As noted above, the front-end of the above-described infrastructure is also representative of a conventional web site (e.g., a set of one or more pages formatted according to a markup language). FIG. 2 illustrates a representative landing page 200 of a display interface for a service customer administrator. Typically, a service customer is an entity (e.g., a brand, advertiser, marketer, or the like) that uses the platform to configure markers and associate those markers to products and services of interest. Upon authentication (and assuming the user has authority), the administrator is presented with landing page and may select among one or more campaigns 202, review a selected campaign, activate or deactivate a particular campaign, search for markers (by type 204, keyword 206, creation date 208, date range 210, and industry 212), and provision new markers by selecting an “Add a Marker” button 214. When the administrator selects the Add a Marker function, a page 300 such as shown in FIG. 3 is displayed. This page includes a number of user controls by which the administrator may provision a marker. Thus, the administrator may select a marker type (e.g., video, 3D object, or the like) 302 and upload the actual content object, identify the marker 304, enter a description 306, select from an industry list 308, configure a marker thumbnail 310, select a call-to-action 312, and select the format (e.g. .jpg) for the marker 314. The format is how the marker is printed (imaged) on the physical substrate to which it is applied (or, more generally, associated). The call-to-action 312 is presented as an overlay on the content object during rendering. Once a marker is configured and associated with a content object, the information is saved, and the marker is available to be used (scanned to enable the content object to be rendered in association with an end user mobile device executing the AR rendering engine.

Of course, the particular layout and configuration of the pages 200 and 300 is merely exemplary and should not be taken as limiting.

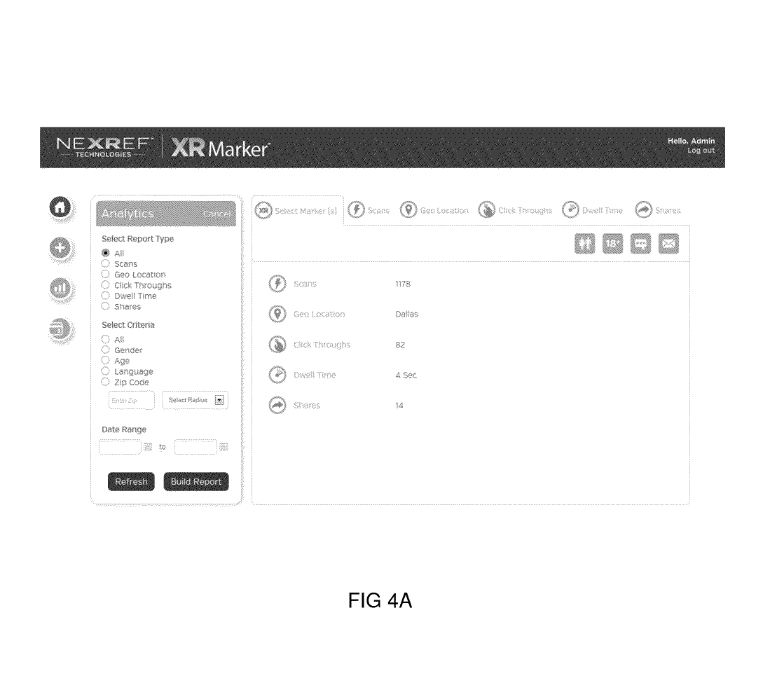

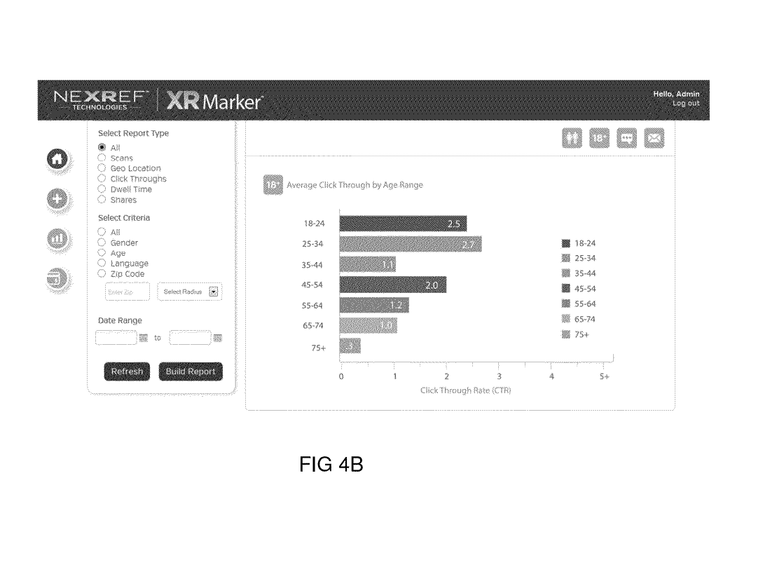

FIG. 4A is a representative display interface by which an administrator can access basic analytical reports on the marker campaigns run by the administrator. FIG. 4B is a representative display interface by which an administrator can access advanced analytical reports on the marker campaigns run by the administrator.

FIG. 5 is a first embodiment of a marker according to the teachings herein. Preferably, a marker 400 has a first code region 402 that encodes an identifier associated with one of a fixed number of identifiers (e.g., up to 80) in a marker bundle. The marker bundle is adapted to be provided to the mobile application runtime environment, preferably in advance of a scanning operation. Each marker also has a second code region 404, preferably located within the first code region, and that encodes additional information, e.g., information identifying a product, a service, an advertiser, a marketer, a marketing campaign, or the like, or some combination thereof. In particular, the second code region is located within an octagon 406, which represents a delimiter (separating the second (internal) code region from the first (external) code region. Additional ornamentation 408 may be provided surrounding the periphery of the first code region.

The first code region illustrated in FIG. 5 is one example first code region; typically, there are a relatively small (e.g., 80) number of variations of the first code region, with each variation having a unique and different arrangement of outwardly projecting sector elements. Some of the sector elements, such as element 405, are unbroken (and thus are all black), and some sectors, such as element 407, are broken (and thus include some white space). The particular location of the white space within a sector element may vary. In this manner, the sector elements within the first code region encode a first data string that has a unique value (e.g., an integer, between 1 and 80). Each variation on the first code region as represented by the particular sector elements (one variation being shown in FIG. 5) produces a first data string with the unique value. Preferably, however many identifiers there may be, taken together, comprise a “bundle.” Preferably, each identifier in the bundle is associated with its own “marker” that is provisioned using the display interface (such as shown above in FIG. 3). The administrator preferably generates the set of markers, which are then processed into the bundle. Although the set of identifiers (the bundle) may be configured in any manner, preferably the bundle is configured in an AR-useable format, such as the Unity 3D file format. The Vuforia Software Development Kit (SDK) or some equivalent may be used for this purpose, all in a known manner. Other file formats may be used for the bundle data.

The second code region illustrated in FIG. 5 is one example second code region, although the amount of information that is encoded (or capable of being encoded) in the second code region is many orders of magnitude greater than that provided by the first code region. In this embodiment, the encoding within the second code region 404 is provided by circular element 408 that includes up to “n” positions corresponding to the 2^{n-m} values for a second data string where m is the number of bits reserved for error detection and correction. Each of the bit values is either 0 (black) or 1 (white). The circular element thus encodes the second data string as a value between 1 and 2^{n-m}. Each second data string value then varies based on the configuration of black and white elements within the circular element 408. Thus, when the value encoded by the first data string (the 1 of 80 markers) is concatenated with the value encoded by the second data string (the 1 of 2^{n-m} Internal IDs), a unique “marker identifier” is generated. In particular, the value (created by the first data string_second data string concatenation) represents a provider, a bundle, and one-to-many content objects associated therewith, typically those provisioned in the manner previously described.

As one of ordinary skill will appreciate, by using the provisioning platform and the encoding scheme, service customers can provision their markers and associate those markers with AR-generated content in an efficient, secure, simple and reliable manner. Moreover, the encoding scheme envisions that large numbers of customers use the platform concurrently and create markers in a highly-scalable manner.

Once a marker is generated and associated with an object to be scanned, the customer is assured that the intended end user will obtain a high quality AR-experience when the marker is later scanned and the content object (associated to the marker) rendered. To that end, when a marker is scanned, the first code region is scanned first; the result of the scan is compared to the marker bundle (which preferably is already present on the mobile device) to determine a first data string. The application then switches to a second processing mode (e.g., a native mode) in the runtime environment and the second code region is scanned. The native mode typically refers to an operating mode in which the device operating system and AR-runtime operate use just native components. The second code region is then encoded to determine a second data string. As described above, the first data string is then concatenated with the string data string (e.g., first data string_second data string) to generate the complete marker identifier. That marker identifier is then provided (e.g., via a Web services (SOAP-over-HTTP), REST-based, JSON-based, or other such call) to the network-accessible platform shown in FIG. 1. In response, application logic in the platform processes the call against its internal database of marker identifiers (indexed appropriately) and returns an identifier (e.g., a URI) to a particular content object that the mobile device rendering application then accesses. The URI is a Uniform Resource Locator, and identifies a location on the Internet (or some other network) at which the content object may be fetched. The client rendering engine then fetches the content object (and there may be multiple such content objects) and returns it (or them) to the mobile device AR-run-time. Stated another way, the content object is then streamed or downloaded to the device run-time for rendering in response to the scan. As noted above, the content object itself may be supplemented with one or more overlay call-to-action controls that are accessible by an end user (viewing the content) to perform additional control actions (e.g., make a call, enter into a chat, send a text message, obtain additional information, or the like) upon viewing the content.

The particular order of “first data string” and “second data string” described above is merely exemplary. In addition, the scanning order may be reversed or carried out concurrently depending on the available scanning resources.

The following provides additional details of a preferred scanning technique implemented in the mobile device app. In particular, when Scan option is selected by user, a dataset containing (e.g., up to 80) external markers is loaded in the memory and the scanner thus looks for external marker in the physical marker being scanned. As soon as the external marker is detected and an External ID retrieved, the native Internal ID decoding program starts scanning each subsequent frame on-demand (e.g., using OpenCV technology), binarizes each frame, detects the internal marker region, applies perspective correction to it, and then detects the demarcator shape in the internal marker; taking this shape as a reference, the program detects the black and white ray elements in a circular fashion and converts those black and white pixel values to a series of 1s and 0s. For example, assume there are “n” such ray elements in the internal marker. After decoding into a binary string, there are “n” binary digits. A certain number “m” of the bits in this binary string preferably contain an error correction bit. If the checksum calculated by the error correction bit is not consistent with the arrangement of the remaining (n−m) bits, the Internal ID is taken as corrupt and another frame is requested from the camera. This process continues until a valid Internal ID is obtained. The marker is then considered to be detected as a whole, and the composite marker id is the Internal_Marker_ID_Exernal_Marker_ID. As described, this composite id is then used in a Web service call, which returns the content metadata information (e.g., in an XML format) corresponding to the marker. Preferably, the meta XML includes information such as type of content, remote address of the content, title, description, and information to render dynamic interactive call-to-action buttons.

Generalizing, the system comprises a mobile-based mobile application (“mobile app”) and AR-run-time engine, together with a web-based back-end that allows customers (e.g., brands, advertisers, marketers or others) to publish their video and 3D object-based advertisements or other content, which content can then be viewed (e.g., by consumers or end users) with the app using a specified marker.

A mobile device includes a client application to facilitate one or more client-side operations. As noted above, the client also includes an augmented reality software run-time environment. In this example, the mobile device is an Apple iPhone, iPad® or iPad2, iPad Mini, an Android™-based smartphone or tablet, a Windows®-based smartphone or tablet, or the like. Preferably, the mobile device is a smartphone or tablet, such as the iPhone® or iPad®, but this is not a limitation. The device of this type typically comprises a CPU (central processing unit), such as any Intel- or AMD-based chip, computer memory, such as RAM, and a drive. The device includes one or more cameras that may be used to scan objects that include markers. The device software includes an operating system (e.g., Apple iOS, Google® Android™, or the like), and generic support applications and utilities. The device may also include a graphics processing unit (GPU). In particular, the mobile device also includes a touch-sensing device or interface configured to receive input from a user's touch and to send this information to processor. The touch-sensing device typically is a touch screen. The touch-sensing device or interface recognizes touches, as well as the position, motion and magnitude of touches on a touch sensitive surface (gestures). In operation, the touch-sensing device detects and reports the touches to the processor, which then interpret the touches in accordance with its programming. Typically, the touch screen is positioned over or in front of a display screen, integrated with a display device, or it can be a separate component, such as a touch pad. The touch-sensing device is based on sensing technologies including, without limitation, capacitive sensing, resistive sensing, surface acoustic wave sensing, pressure sensing, optical sensing, and/or the like. The mobile device comprises suitable programming to facilitate gesture-based control, in a manner that is known in the art.

More generally, the mobile device is any wireless client device, e.g., a cellphone, pager, a personal digital assistant (PDA, e.g., with GPRS NIC), a mobile computer with a smartphone client, or the like. Other mobile devices in which the technique may be practiced include any access protocol-enabled device (e.g., a Blackberry® device, an Android™-based device, or the like) that is capable of sending and receiving data in a wireless manner using a wireless protocol. Typical wireless protocols are: WiFi, GSM/GPRS, CDMA, Bluetooth, RF or WiMax. These protocols implement the ISO/OSI Physical and Data Link layers (Layers 1 & 2) upon which a traditional networking stack is built, complete with IP, TCP, SSL/TLS and HTTP.

In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (EMS), multi-media message (MMS), email, WAP, paging, or other known or later-developed wireless data formats. The techniques herein may be implemented within other mobile networking technologies and implementation architectures, such as LTE. Generalizing, a mobile device as used herein is a 3G- (or next generations) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The techniques disclosed herein are not limited for use with a mobile device that uses a particular access protocol. The mobile device typically also has support for wireless local area network (WLAN) technologies, such as Wi-Fi. WLAN is based on IEEE 802.11 standards.

The client is not limited to a mobile device, as it may be a conventional desktop, laptop or other Internet-accessible machine running a web browser or equivalent rendering engine.

As noted above with respect to FIG. 1, system that comprises a web-based administrative console for customers or other entities (advertisers/marketers), together with a mobile client for consumers. The system is provided from a network presence that comprises a web-based front-end, back-end application servers and database servers, and other administrative servers (e.g., for data collection, reporting, billing, and management). The system includes a file system.

A permitted user (administrator) registers to the system and logs in using the administrative console to provision these codes for particular products/objects being managed by the system.

The following provides additional detail regarding an end-to-end system.

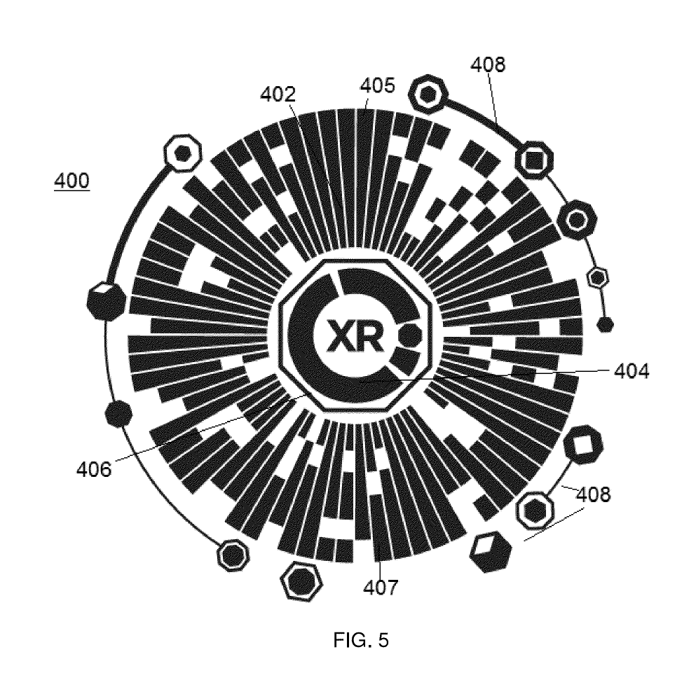

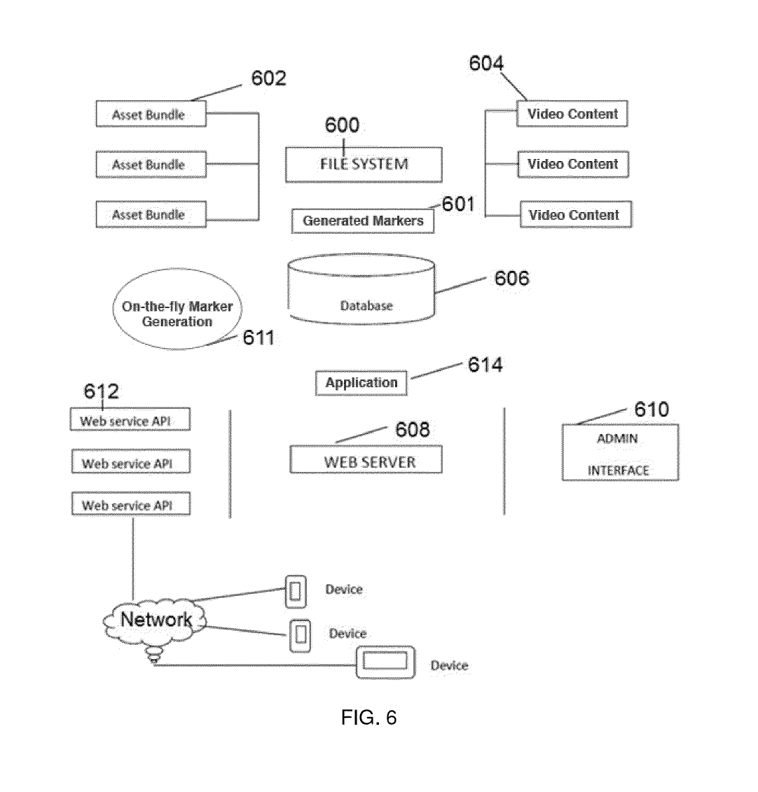

FIG. 6 is a simplified block diagram of the basic components of server-side architecture for use herein. In this paradigm, a file system 600 comprises one or more asset bundles 602 and video files 604, e.g., in one of MOV, MP4 and .M4V formats. An asset bundle 602 refers to a set of content 3D models/objects that have been uploaded to the platform, typically by or on behalf of a provider. A database 606 stores information that associates a marker code with a bundle path/video path. A web server 608 provides a web-accessible front end (e.g., a set of web pages, a website, etc.). Typically, and as noted above, end user mobile devices interact with the web server via Web services application programming interfaces (APIs). An administrative interface 610 (as shown in FIGS. 2-3, by way of example) provides a console through which authorized entities (e.g., customers) provision their assets.

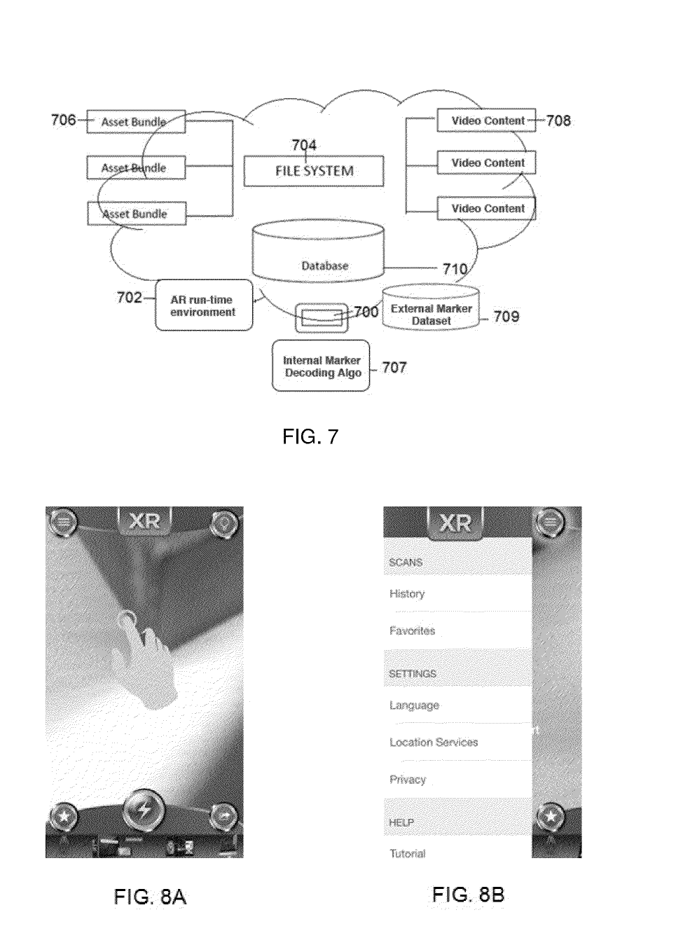

FIG. 7 is a block diagram of the basic components of client-side architecture for use herein. As noted, a client end user is associated with a mobile device 700 that executes an AR software run-time 702. The client also includes a file system 704 that supports asset bundles 706 and a database 710, which provides local file system-based storage. The app contains the packaged marker dataset of (e.g., up to 80) markers 709 and also hosts the second code region decoding functionality 707.

According to another aspect, the disclosure also describes a technique to generate an unlimited number of unique markers that are preferably two-dimensional (2D) patterned images. The administrative console (or some device, system, program, or the like) also preferably provides the functionality for the customer to download, print and distribute the linked markers.

On the client side, as has been described, the mobile app provides end user consumers the ability to scan such markers wherever they find them, and to explore the hidden content encoded or otherwise associated therewith, such as video ads or 3D animation ads. Preferably, a scan history is saved on the end user mobile device so that an ad once viewed need not be scanned again and can be viewed later in History screen via Settings Panel. It also provides the user the ability to clear the history. Also, a Settings panel allows the user to toggle GPS access, set Language preference, View Tutorial, View Favorites, View History and the like. The main display screen preferably exposes several options such as Scan option, Mark Favorite option, turn on flash light option, Share with Social Media option. Scan Screen with camera and these aforesaid options is the default screen.

While using the Scan feature, a user holds the device in front of an image marker. The image marker contains the unique External Marker Pattern (FIG. 4, 402, FIG. 5, 502), together with an Internal Marker Pattern (FIG. 4, 404 or FIG. 5, 504).

An asset is a video ad or 3D object/animation which is rendered on the device when a given marker is successfully scanned. If the asset happens to be a video, it starts playing automatically as it is streamed. In case of 3D objects, the assets are downloaded first and then rendered. Such assets are interactive and respond to marker movements and user touches.

If necessary, the actual data objects needed by the AR software module are fetched (either from local cache, or remotely) and content is rendered to the end user.

The markers may be used on or in association with any physical, logical or virtual item. Representative items may be one of: restaurant menus, real estate signs, store displays, magazine advertisements, hospitals, instruction manuals, outdoor billboards, clothing apparel and on-line items associated therewith. Markers are described herein are much more useful than a QR or other code formats for several reasons: the ability to enable streaming live content, storing (and digitally presenting) large amounts of data including product demonstrations, geo-coordinates, and text. The markers are compact, and they fit neatly in the smallest and sometimes the most expensive locations that bring brand awareness.

The subject matter herein provides significant advantages. A main advantage is to provide a better AR experience for the end user. As described, a primary functionality of the app allows allow the end user to open up the device and scan marker images and stream video or render digital 3D objects corresponding to the scanned entities. If the downloaded entity happens to be a video, it renders automatically, and preferably the user has access to a full screen feature and other video controls like play pause volume, and the like. The end user may also have access to one or more control objects that are overlaid on the content being rendered. If the downloaded entity is a 3D object, the app allows the user to interact with the 3D object. The end user is able to toggle permission settings such as camera access, GPS access, Internet access, and the like. Preferably, the app recognizes GPS location, compass location and triangular location along with altitude. With permission, the app may also track travel patterns of the user, and it may support facial recognition that can be linked to a person's social network. For the app user, a history tab provides an interface by which the user can view the videos and the 3D objects he/she has watched.

On the server side, a platform exposes a web-accessible module by which platform customers upload their own scan-able entities, geo-tag them, and associate them with videos or 3D objects. In one embodiment, the platform includes an administrative console implemented and hosted in Microsoft .NET framework with SQL server as back end database. This console allows a customer to login to his or her account, create new campaigns, enter information and associate video or 3D object files and choose a marker from a catalog of markers for that campaign. Each marker can have more than one video asset associated to it in different languages. The videos are played in the language configured by the user in the app. In addition, interactive buttons can be configured for each asset. The interactive buttons profiles are configured and a certain maximum number of the profiles can be assigned while uploading video and assigning to a marker form the admin console.

As has been described, preferably, the platform also exposes a Unity 3D or equivalent development environment. The marker images are uploaded by the Vuforia Target Manager web console and configured with their respective bundle names as folder names. Vuforia allows each bundle to hold up to 100 markers considering scalability and performance aspects. A marker bundle is a package generated by the Vuforia in various platform specific formats. It essentially comprises a .DAT and an .XML file. The mobile device scan module may be implemented using Qualcomm's Vuforia SDK for Unity3D.

Typically, the corresponding video URL (for video) or the FBX or other supported file format URL (for 3D objects) is determined by the mobile device run-time, such as the Vuforia SDK. A 3D file stores the 3D representation and motion information for 3D objects. The custom logic for interaction with the 3D objects preferably is written in Unity3D. In Apple iOS, the video is streamed using AVPlayer. The tracking of the video is done by transforming unity3D co-ordinates, which are tracked by Vuforia SDK into IOS and the video layer is superimposed on the marker.

The user interface in the mobile app enables the end user to scan markers, interact with the AR content using the call-to-action buttons configured for the content, save a History and Favorites, share information with social networking sites (e.g., Facebook, Twitter and others), and the like.

FIG. 8A shows a home screen of a mobile device app that hosts the marker scan functionality of this disclosure. FIG. 8B shows a navigation panel that enables a user to explore other screens in the app, to change app settings, and to display other information about the application.

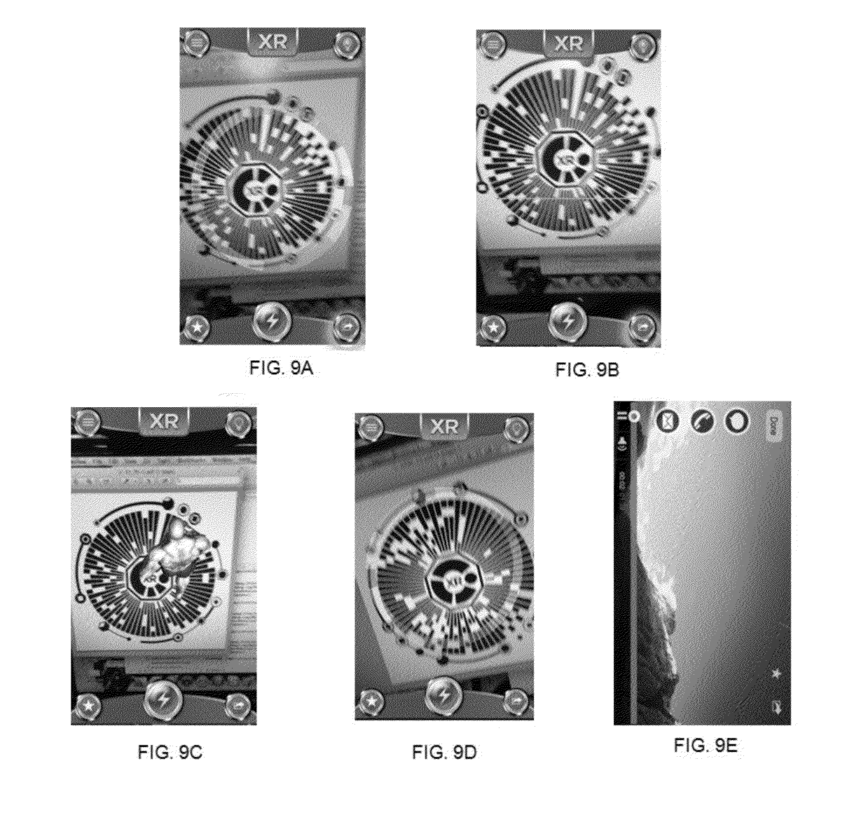

FIG. 9A shows a scanner animation that is displayed in a main screen when a marker is being scanned. FIG. 9B shows the scanner screen of the app when a marker pointing to 3D content is scanned successfully and downloads the content to the device before rendering. FIG. 9C shows the scanner screen of the app when the 3D content is successfully augmented on the marker. FIG. 9D shows the scanner screen of the app in the main screen when a marker pointing to remote video content is scanned. FIG. 9E shows the scanner screen of the app when the video scanned is successfully augmented and automatically rendered in a full screen mode, together with the call-to-action buttons configured for the marker by the administrator.

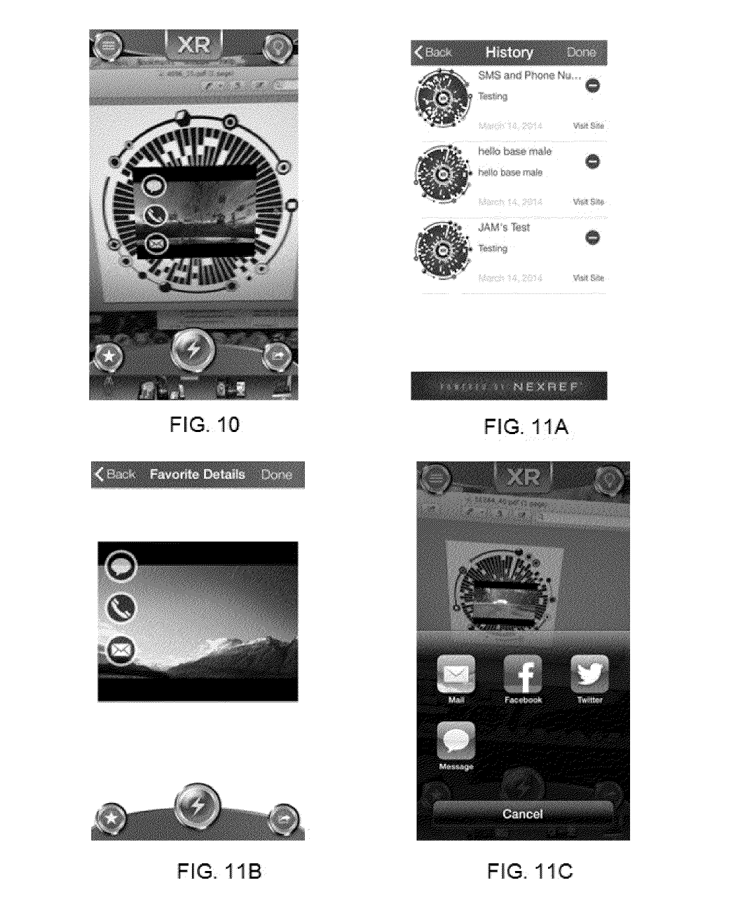

FIG. 10 shows the scanner screen when a marker is scanned for video content with several call-to-action buttons and in augmented mode (as opposed to full screen mode).

FIG. 11A shows a History screen of the app by which a user can view the list of all the markers scanned. FIG. 11B shows the display of the content of a marker item when selected from the History or Favorites List View screen. FIG. 11C shows a popup screen that appears when a Social Media Share button is tapped for the scanned content in the scanner screen.

The above-described display screens are merely representative and are not intended to limit the scope of this disclosure.

In the mobile app, a launch screen hosts the scanner functionality. Preferably, the screen shows a “Tap-to-Scan” functionality with the scanner in inactive mode whenever the user navigates to other screens or comes to this screen. When a user taps the Scan button, a scanner ring appears animating, and the scanner camera becomes active. When a marker comes inside the view of the camera (e.g., FIG. 9A) and points to interactive 3D content, the marker is scanned in a few seconds and the corresponding 3D content is downloaded to the device (if not cached there). The content is then rendered in augmented mode over the marker (e.g., FIG. 9C). When a marker being scanned points to a video, however, preferably the video is not downloaded, but rather, it is streamed to the app and rendered directly (e.g., FIG. 9E, in a full-screen mode, and FIG. 10 in an augmented mode. These figures also show the call-to-action button overlaid on the scanned video. Preferably, and as described above, these buttons are configured from the administration console, potentially for each individual marker (or a group of markers). Representative call-to-action buttons are Phone, SMS, Email, Info, Website, Location, Shop/Buy Now, VCard, etc. Tapping the interactive Phone button takes the user to the native phone caller functionality, preferably with the Phone number configured for the marker from the administrative console. Tapping SMS takes the user to the SMS controller with the configured Phone number. Tapping Email takes the user to the email creation view with the email id configured for the marker. Info button opens up a popup view to display additional information configured for the marker. Tapping Website buttons opens up the website link configured for the marker. Tapping Location buttons opens up the map and shows the coordinate location as configured for the marker. VCard button provides an option to the user to save/share a contact in the form of a VCard.

While given components of the system have been described separately, one of ordinary skills will appreciate that some of the functions may be combined or shared in given instructions, program sequences, code portions, and the like.

Having described our invention, what we now claim is set forth below.

1. An article comprising a tangible, non-transitory machine-readable medium that stores a program, the program being executable by a machine having a hardware component, comprising:
program code to receive data associating a set of markers with a set of content objects, the content objects, wherein each marker is adapted to be associated with an item and has a first code region, and a second code region, the second code region located within or adjacent the second code region, the first code region adapted for pattern recognition against a marker dataset and encoding a first data string identifying a content object in a bundle of objects, the second code region adapted for decoding without reference to the marker dataset and encoding a second data string identifying the bundle of objects;
program code to receive, from a requesting client device having an augmented reality run-time environment, information obtained from scanning a marker, the information comprising the first data string and the second data string, and to return in response an identifier associated with a particular one of the content objects; and
program code to receive the identifier and return the particular one of the content objects for rendering in the augmented reality run-time environment.

2. The article as described in claim 1 wherein a content object is one of: a 3D object, and a video object.

3. The article as described in claim 1 wherein the second code region is uniquely associated with a provider, the provider being a source of products or services, each of the products or services uniquely associated with a content object in the bundle of objects.

4. The article as described in claim 3 wherein the each object in the bundle of objects is associated with a product or service SKU.

5. The article as described in claim 1 wherein the first code region is generally circular and includes a central area.

6. The article as described in claim 5 wherein the second code region is located with the central area of the first code region.

7. The article as described in claim 1 further including program code to generate, programmatically, a set of markers that include the marker, each marker in the set of markers including a variant of the first code region, and a distinct second code region.

8. The article as described in claim 1 wherein a content object is an advertisement.

9. The article as described in claim 1 wherein the program code to receive data includes an administrative console that is shared by first and second entities, the administrative console adapted to provision content objects with markers.

10. The article as described in claim 1 wherein a content object is provisioned with an additional call-to-action control.
